(19) United States
(12) Patent Application Publication
(10) Pub. No.: US 2009/0260234 A1
(43) Pub. Date: Oct. 22, 2009

(54) FOLDABLE HAND TOOL

(76) Inventor: Chin Tsai LAI, Taichung City (TW)

Correspondence Address: Chien-Hui Su, P. O. Box 70-121 Taichung, Taichung City, 40899, TW

(21) Appl. No.: 12/107,059

(22) Filed: Apr. 21, 2008

(51) Int. Cl. B26B 1/04

(52) U.S. Cl. 30/161

(57) ABSTRACT

A foldable hand tool includes a handle having a hole laterally defined in a font end of the handle for pivotally connecting to a working element. The working element has a pivotal end pivotally received in the front end and a polygonal hole which is centrally defined in the pivotal end. A groove is radially defined in the pivotal end and communicates with the polygonal hole. A locking element is reciprocally movably mounted in the hole in the handle for selectively positioning the working element.

### BACKGROUND OF THE INVENTION

1. Field of the Invention

The present invention relates to a foldable hand tool, and more particularly to a foldable hand tool that has a replaceable and adjustable working element for different work types.

2. Description of Related Art

A conventional hand tool in accordance with the prior art comprises a handle having a slot defined in a front end of the handle along with a axis of the handle for selectively receiving a working element, wherein the working element is pivotally connected to the front end of the handle and received in the slot when the conventional hand tool is folded.

The conventional hand tool is foldable for being carried easily. However, the conventional hand tool still has some defects and needs to be advantageously altered. The conventional hand tool can not exchange or replace the working element when being broken such that the user should prepare a lot of the hand tools in advance for contingent use. It costs a lot and need a lot of space in storage. Especially, it's too heavy to carry all kind of the conventional hand tools with the user every time.

The present invention has arisen to mitigate and/or obviate the disadvantages of the conventional hand tool.

### SUMMARY OF THE INVENTION

The main objective of the present invention is to provide an improved foldable hand tool, which has a replaceable and adjustable working element.

To achieve the objective, the foldable hand tool in accordance with the present invention comprises a handle having a hole laterally defined in a font end of the handle for pivotally connecting to a working element. The working element has a pivotal end pivotally received in the front end of the handle and a polygonal hole which is centrally defined in the pivotal end. A groove is radially defined in the pivotal end and communicates with the polygonal hole. A locking element is reciprocally movably mounted in the hole in the handle for selectively positioning the working element.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a foldable hand tool in accordance with the present invention;

FIG. 2 is a perspective view of the foldable hand tool in accordance with the present invention;

FIG. 3 is a side cross-sectional view of the front end of the handle for showing the relative position of the locking element when the working element is locked;

FIG. 4 is a side cross-sectional view of the front end of the handle for showing the relative position of the locking element when the working element is in a free condition;

FIG. 5 is a side cross-sectional view of the front end of the handle for showing the relative position of the locking element when the working element is detached from the handle;

FIG. 6 is a side plan view of the foldable hand tool when the working element stretch out of the handle and the locking element is pressed; and

FIG. 7 is a side plan view of the foldable hand tool when the working element is detached from the handle.

### DETAILED DESCRIPTION OF THE INVENTION

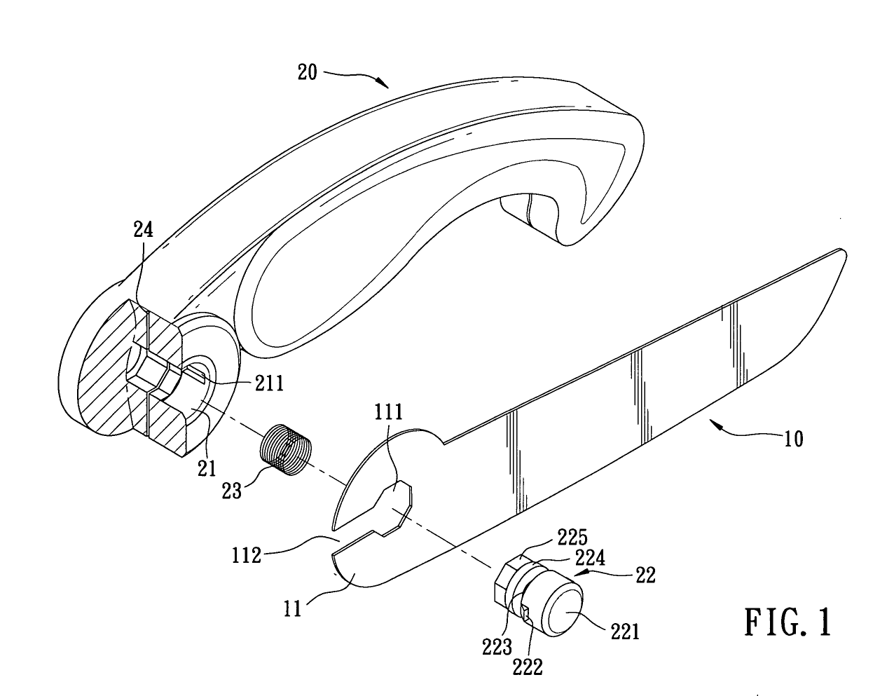

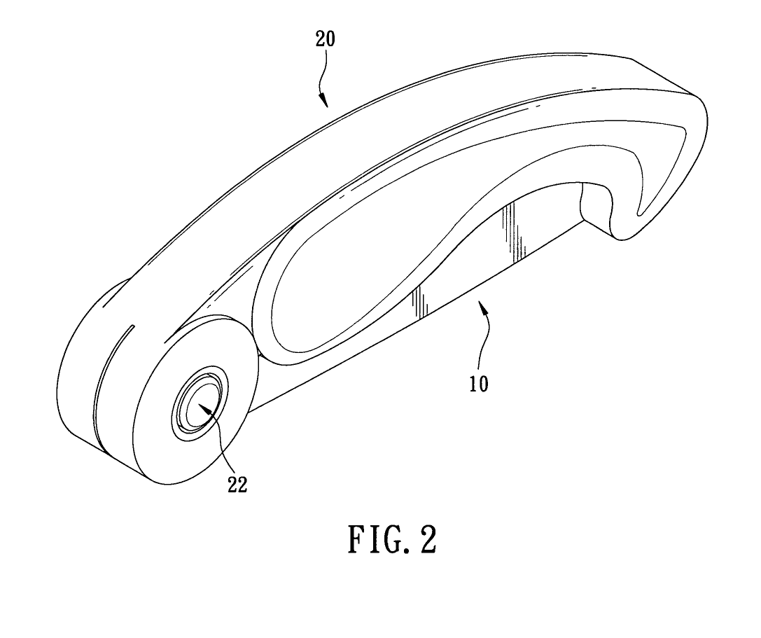

Referring to the drawings and initially to FIGS. 1-2, a foldable hand tool in accordance with the present invention comprises a handle (20), a working element (10) pivotally detachably connected to a front end of the handle (20) and a locking element (22) movably mounted in the front end of the handle (20) for selectively positioning the working element (10).

The handle (20) has a hole (21) laterally defined in the front end thereof. A slot (24) is defined in the front end of the handle (20) along an axis of the handle (20) and communicating with the hole (21). At least one rut (211) is longitudinally defined in an inner periphery of the hole (21). In the preferred embodiment of the present invention, there are two ruts (211) longitudinally defined in the inner periphery of the hole (21) and diametrically corresponding to each other.

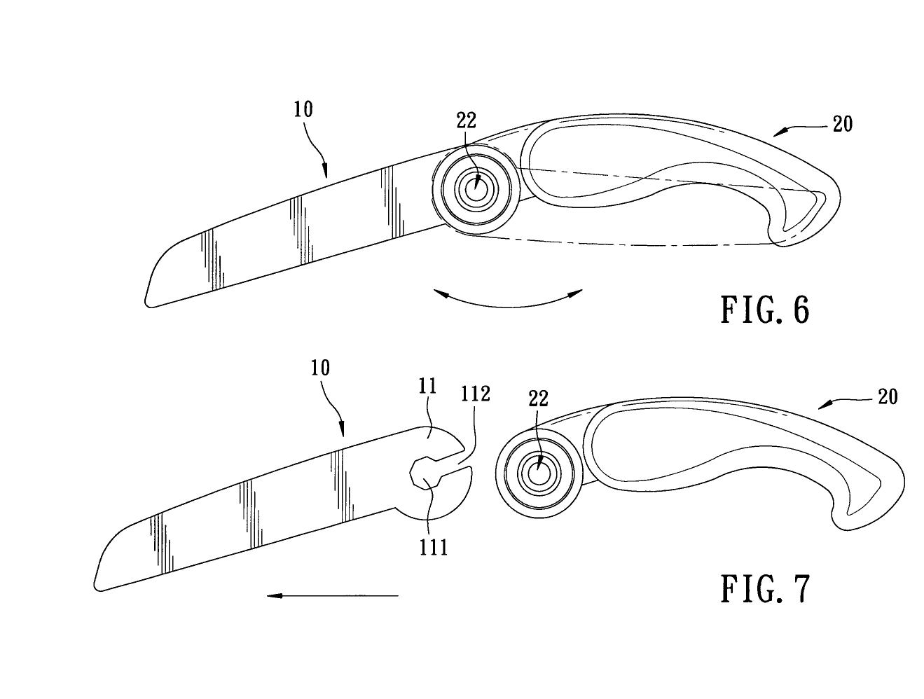

With reference to FIGS. 1 and 6, the working element (10) has a pivotal end (11) pivotally received in the slot (24) in the front end of the handle (20). A polygonal hole (111) is centrally defined in the pivotal end (11), and a groove (112) is radially defined in the pivotal end (11) and communicating with the polygonal hole (111). The working element (10) is a saw, a wrench, a spade, and the like for different work types.

An elastic member (23) and a locking element (22) are sequentially mounted in the hole (21) of the handle (20). The elastic member (23) has two opposite ends respectively abutting against a bottom of the hole (21) and an inner end of a locking element (22) for providing a restitution force to the locking element (22). In the preferred embodiment of the present invention, the elastic member (23) is a compression spring which is compressively mounted in the hole (21).

The locking element (22) is longitudinally movably received in the hole (21) of the handle (20). A polygonal portion (225) is formed on the inner end of the locking element (22) and selectively received in the polygonal hole (111) of the working element (10) for locking the working element (10). A button (221) is formed on an outer end of the locking element (22) for user to operate the locking element (22). At least one latch (222) laterally extends from an outer periphery of the button (221) and is slidably received in the at least one rut (211) in the handle (20) to prevent the locking element (22) from detaching from the front end of the handle (20). In the preferred embodiment of the present invention, the number of the latch (222) is decided relative to that of the rut (211) such that there are two latches (222) laterally extending from the outer periphery of the button (221) and diametrically corresponding to each other, wherein each latch (222) is slidably received in a corresponding one of the two ruts (211) such that the locking element (22) does not be rotated relative to the handle (20). A neck (223) is formed between the polygonal portion (225) and the button (221). The neck (223) has a diameter smaller than a width of the groove (112). A pivotal portion (224) is formed between the polygonal portion (225) and the neck (223). The pivotal portion (224) has a periphery which is an inscribed circle of the polygonal hole (111) of the working element (10).

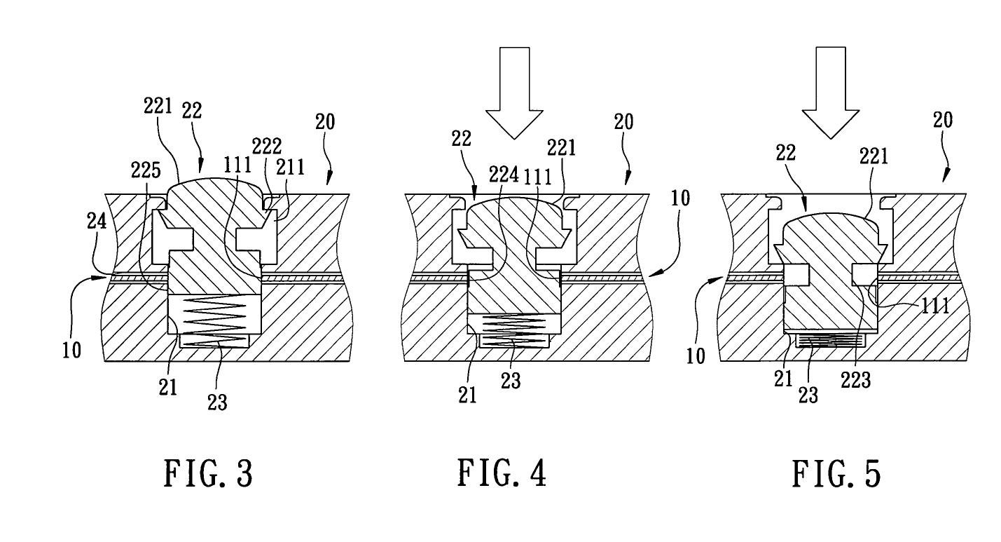

With reference to FIG. 3, the polygonal portion (225) is received in the polygonal hole (111) for locking the working element (10) due to the restitution force of the elastic member (23) when the locking element (10) is in a free condition. As a result, the user can safely operate the foldable hand tool.

With reference to FIG. 4 and FIG. 6, the pivotal portion (224) is received in the polygonal hole (111) to make the working element (10) is in a free condition when the button (221) is pressed. After the working element (10) adjusted to a specific angle, the polygonal portion (225) is newly received in the polygonal hole (111) for locking the working element (10) again due to the restitution force of the elastic member (23) when the button (221) is released.

With reference to FIG. 5 and FIG. 7, the button (221) is pressed to make the neck (223) received in the polygonal hole (111) such that the user can detach the working element (10) when the neck (223) is pressed through the groove (112).

With reference to FIG. 5 and FIG. 3, another/a new working element is mounted in the slot (24) for replacing the used working element (10) when the neck (223) is aligned with the slot (24). The polygonal portion (225) is received in the polygonal hole (111) for locking another/a new working element again due to the restitution force of elastic member (23) when the button (221) is released.

Although the invention has been explained in relation to its preferred embodiment, it is to be understood that many other possible modifications and variations can be made without departing from the spirit and scope of the invention as hereinafter claimed.

What is claimed is:

1. A foldable hand tool comprising:
a handle having a hole laterally defined in a font end of the handle for pivotally connecting to a working element;
the working element having a pivotal end pivotally received in the front end of the handle and a polygonal hole centrally defined in the pivotal end, the polygonal hole longitudinally communicating with the hole in the handle when the pivotal end received in the front end of the handle, a groove radially defined in the pivotal end and communicating with the polygonal hole; and
a locking element reciprocally movably mounted in the hole of the handle for selectively positioning the working element, wherein the locking element is limited to prevent the locking element from being rotated relative to the handle.

2. The foldable hand tool as claimed in claim 1, wherein the locking element has a polygonal portion formed on an inner end thereof for locking the working element when being received in the polygonal hole in the working element.

3. The foldable hand tool as claimed in claim 1, wherein the working element has a neck formed thereon, the neck has a diameter smaller than a width of the groove such that the working element can be detached from the handle when the neck is received in the polygonal hole.

4. The foldable hand tool as claimed in claim 1, wherein the locking element has a pivotal portion formed thereon, the pivotal portion having a periphery be an inscribed circle of the polygonal hole for pivoting the working element such that the working can be freely rotated relative to the handle when the pivotal portion is received in the polygonal hole.

5. The foldable hand tool as claimed in claim 1 further comprising an elastic member compressively mounted in the hole between the locking element and the bottom of the hole for providing a restitution force to the locking element.

6. The foldable hand tool as claimed in claim 5, wherein the elastic member is a spring.

7. The foldable hand tool as claimed in claim 1, wherein the handle has a slot defined in the front end of the handle along the axis of the handle and communicating with the hole, and the pivotal end of the working element is selectively and pivotally received in the slot.

8. The foldable hand tool as claimed in claim 1, wherein the handle has at least one rut longitudinally defined in an inner periphery of the hole of the handle and the locking element has at least one latch laterally extending from an outer periphery of the locking element, the at least one latch slidably received in the at least one rot to prevent the locking element from being rotated relative to the handle.
